(19) United States
(12) Patent Application Publication
(10) Pub. No.: US 2015/0020674 A1
(43) Pub. Date: Jan. 22, 2015

(54) Device for Playing a String Musical Instrument

(71) Applicant: P.M.D-PRO MUSIC DEVELOPMENTS LTD., Tel Aviv (IL)

(72) Inventors: Yehoshua Sender, Kiriat Mozkin (IL); Noam Sander, Hod Hasharon (IL)

(21) Appl. No.: 14/382,576

(22) PCT Filed: Mar. 4, 2013
(86) PCT No.: PCT/IL2013/050191

§ 371 Date: Sep. 3, 2014

Related U.S. Application Data
(60) Provisional application No. 61/606,495, filed on Mar. 5, 2012.

(51) Int. Cl. G10D 3/16

(52) U.S. Cl. CPC G10D 3/163
USPC 84/320

(57) ABSTRACT

A device for playing a stringed musical instrument comprises (a) a handle-like member to be gripped by a hand of a user; (b) a plectrum; and (c) a holder of said plectrum mechanically connected to the aforesaid member. The holder is configured for releasably fixating said plectrum therewithin. The plectrum holder is pivotally connected to the member such that an axis of rotation is in a plane of the plectrum and substantially parallel to instrument strings.

### FIELD OF THE INVENTION

The present invention generally relates to musical instruments and particularly to means for playing string instruments such as guitar. More specifically the invention concerns an auxiliary device for holding plectrums by which the string instruments are played.

### BACKGROUND OF THE INVENTION

As a rule, plectrums (commonly referred to as picks) are held by the player between the forefinger and the thumb and so plucked against the strings to produce the sound. This traditional arrangement has not been changed for centuries in spite of various improvements and modifications of the playing instruments proper, for example, the so-called “electric” guitar and its variations.

It is known that there are several mechanisms that influence the radiated sound production of the guitar or other plucked instrument:(i) the plucking position along the string; (ii) the initial displacement of the string, which is related to the plucking force; (iii) the shape of the string deformation before being released, which is related to the characteristics of the plucking object; (iv) the direction of plucking.

U.S. Pat. No. 6,242,677 discloses a plectrum holding device for playing the guitar and the like string musical instruments comprising an elongated body member, a butt-like rear member mounted to one end of the body member and configured to rest against the thumb root of the player, a trigger-like front member mounted to the other end of the body member and configured to be gripped by a forefinger phalanx ankle of the player; and a mounting for plectrum in a plane substantially perpendicular to the plane of rear and front members within reach of the player's thumb on one side and the tip of the player's forefinger on the other side of the plectrum mounting.

There exists a long felt need for improved control of sound production in stringed and plucked instruments.

### SUMMARY OF THE INVENTION

It is hence one object of the invention to disclose a device for playing a string musical instrument. The aforesaid device comprises (a) a handle-like member to be gripped by a hand of a user; (b) a plectrum; and (c) a holder of the plectrum mechanically connected to the member; the holder configured for releasably fixating the plectrum therewithin.

It is a core purpose of the invention to provide the plectrum holder pivotally connected to the member such that an axis of rotation is in a plane of the plectrum and substantially parallel to instrument strings.

Another object of the invention is to disclose the handle-like member configured into a quadrilateral and substantially flat body with concavely shaped anterior side, a posterior side and a lower side.

A further object of the invention is to disclose the posterior side resting on the fascia over adductor pollicis muscle. The anterior side rests on an index finger. The lower side and upper sides are free when said handle-like member is gripped by the user's hand. The plectrum is rotatably movable between a first finger and said index finger.

A further object of the invention is to disclose the posterior side resting on the fascia over adductor pollicis muscle. The anterior side rests on a middle finger. The lower and upper sides are free when said handle-like member is gripped by the user's hand. The plectrum is rotatably movable between a first finger and said middle finger.

A further object of the invention is to disclose a range of plectrum rotation between the user's fingers which is from about 0 to about 120°.

A further object of the invention is to disclose the holder connected to the member by means of a hinge.

A further object of the invention is to disclose the holder integrated with the plectrum.

A further object of the invention is to disclose the integrated plectrum releasably connectable to the member and replaceable as needed.

A further object of the invention is to disclose the integrated plectrum provided a T-profile member which is insertable into a T-slot within the handle-like member.

A further object of the invention is to disclose the device further comprising a wireless unit configured to control a hardware based effects unit connected to said musical instrument and sound effects performable thereby.

A further object of the invention is to disclose the device further comprising a wireless unit configured to control a software based effects unit connected to said musical instrument connected to said musical instrument and sound effects performable thereby.

A further object of the invention is to disclose the device further comprising a wireless unit configured to control an effects unit that includes both hardware and software based functionality, connected to said musical instrument and sound effects performable thereby.

A further object of the invention is to disclose the device further comprising a unit configured for electromagnetic excitation of string oscillation (Ebow).

A further object of the invention is to disclose a device for playing a string musical instrument comprises (a) a handle-like member to be gripped by a hand of a user; and (b) a plectrum arrangement comprising an anchor mechanically connectable to the member and a plectrum.

It is another core purpose of the invention to provide the plectrum pivotally connected to the anchor such that an axis of rotation is in a plane of the plectrum to be and substantially parallel to instrument strings.

A further object of the invention is to disclose a plectrum having an opening configured for pivotally connecting the anchor.

A further object of the invention is to disclose a plectrum arrangement releasably fixatable to a handle-like member to be gripped by a hand of a user. The aforesaid arrangement comprises an anchor mechanically connectable to the member and a plectrum.

It is a further core purpose of the invention to provide the plectrum pivotally connected to the anchor such that an axis of rotation is in a plane of the plectrum to be and substantially parallel to instrument strings.

A further object of the invention is to disclose the plectrum made by an injection molding process.

A further object of the invention is to disclose a plectrum having a slot configured for pivotally connecting to a handle-like member to be gripped by a hand of a user.

A further object of the invention is to disclose the plectrum mechanically connected to an anchor releasably connectable to the handle-like member.

A further object of the invention is to disclose a punch stamp configured for cutting a plectrum having an internal puncheon designed for cutting an opening configured for configured for pivotally connecting to a handle-like member to be gripped by a hand of a user.

A further object of the invention is to disclose the holder comprising a spring-controlled slot configured for receiving and mechanically clamping said plectrum.

A further object of the invention is to disclose the holder comprising a member provided with at least one pin to which a conventionally used plectrum being conformably perforated is mechanically clamped.

A further object of the invention is to disclose the plectrum provided with a heaver providing a forceful swing and an easy string pluck.

A further object of the invention is to disclose the plectrum provided with an opening and said heavier is secured in said opening. A further object of the invention is to disclose the puncheon designed for cutting a slot configured for an anchor releasably connectable to said handle-like member.

A further object of the invention is to disclose a method of playing a musical instrument. The aforesaid method comprises the steps of (a) providing a device for playing a string musical instrument; the device comprising (i) a handle-like member to be gripped by a hand of a user; (ii) a plectrum; and (iii) a holder of the plectrum mechanically connected to the member; the holder configured for releasably fixating the plectrum therewithin; the plectrum holder is pivotally connected to the member such that an axis of rotation is in a plane of the plectrum and substantially parallel to instrument strings; (b) gripping the device by the user's hand; (c) picking the strings by means of the plectrum.

It is a further core purpose of the invention to step of plucking strings which comprises rotating the plectrum around an axis which is in a plane of the plectrum and substantially parallel to instrument strings.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a general view of a device for playing a string musical instrument;

FIGS. 2a and 2b are views of a plectrum arrangement;

FIGS. 3a and 3b are front and side views of a handle-like member;

FIG. 4 is a view of a plectrum; and

FIGS. 5a and 5b are 3b are front views of plectrums which can be provided with a heaver.

### DETAILED DESCRIPTION OF THE INVENTION

The following description is provided, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide a device for playing a stringed musical instrument and a method of playing the same musical instrument.

The term “stringed musical instrument” hereinafter refers to a musical instrument that produces sound by means of vibrating strings. The device of the present invention is essentially applicable to guitar, bass, banjo, mandolin, ukulele, harp, lute, oud, sitar and others.

The terms “plectrum” and “pick” are used in the present application interchangeably

A plectrum is a small flat tool used to pluck or strum a stringed instrument. Playing guitar with a plectrum produces a bright sound compared to plucking with the fingertip. Plectrums also offer a greater contrast in tone across different plucking locations; for example, the difference in brightness between plucking close to the bridge and close to the neck is much greater when using a pick compared to a fingertip.

Guitar plectrums vary in thickness to accommodate different playing styles and kinds of strings. Thinner plectra are more flexible and tend to offer a wider range of sounds, from soft to loud, and produce a “click” that emphasizes the attack of the picking.

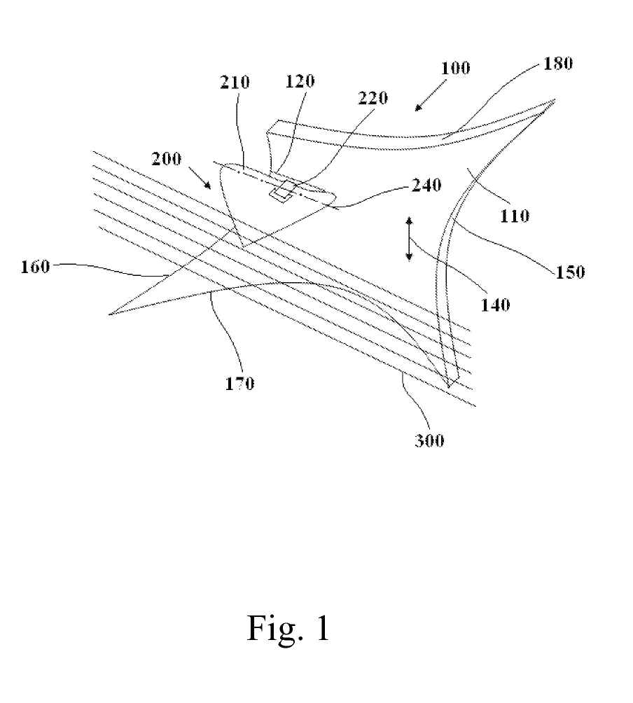

Reference is now made to FIG. 1, showing a general view of a device for playing a string musical instrument. The device comprises a handle-like member 100 to be gripped by a hand of a user, and a plectrum arrangement 200. The device gripped by a hand of a user (not shown) is displaced perpendicularly to the strings 300. Sound is produced due to the plectrum plucking the strings. The plectrum 210 is rotatable about an axis 240 which is oriented substantially parallel to the strings. The aforesaid axis is in a plane of the plectrum 210. The amplitude of plectrum rotation is limited by the positioning of the user's fingers. In accordance with the preferred embodiment of the present invention, the amplitude of the plectrum motion is limited by first (thumb) and index or middle fingers (not shown).

Specifically, the handle-like member 100 is configured into a quadrilateral and substantially flat body with concavely shaped anterior side 160, a posterior side 150 and a lower side 170.

The posterior side 150 rests on the fascia over the adductor pollicis muscle of the user's hand. The anterior side 160 rests on index or middle finger. The lower side and said upper sides are free when said handle-like member is gripped by the user's hand. The plectrum is rotatably movable between a first finger and said index finger. A range of plectrum rotation between the user's fingers is from about 0 to about 120°.

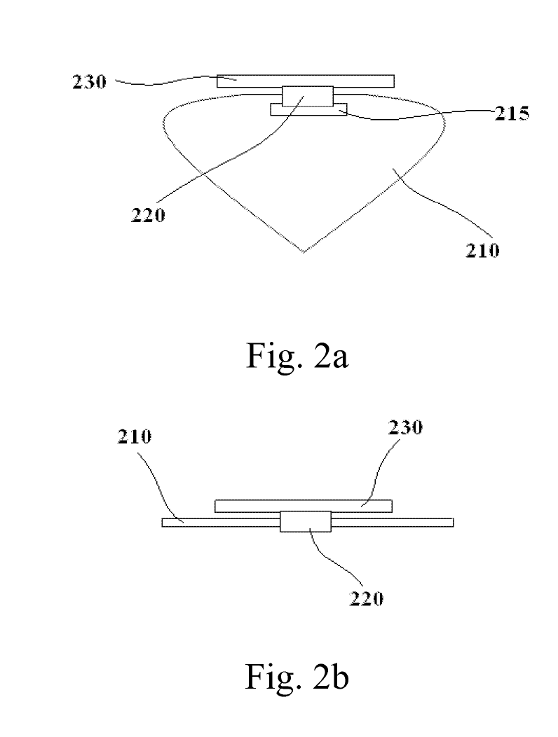

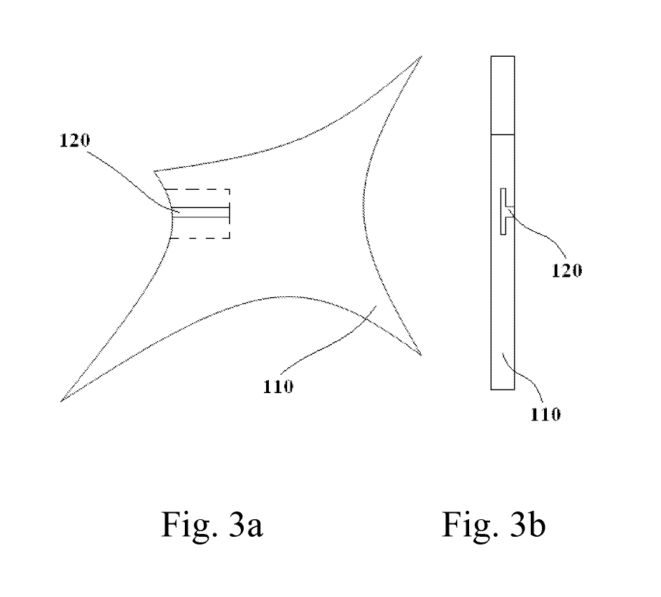

Reference is now made to FIGS. 2a and 2b, presenting the plectrum arrangement in two positions. FIG. 2a shows the position of the plectrum 210 which is perpendicular to a body of the handle-like member (not shown). FIG. 2b shows the position of the plectrum 210 which is parallel to a body of the handle-like member. The plectrum arrangement is releasably fixatable to a handle-like member to be gripped by the user's hand. The plectrum arrangement comprises an anchor 230 insertable into a slot 120 (see FIGS. 3a and 3b). The 210 plectrum is pivotally connected to the anchor 230 by means of an annulus 220 such that the plectrum is rotatable about an axis of rotation which is in a plane of the 210 plectrum. Thus, the plectrum arrangement is a replaceable portion of the device for playing stringed instruments and can be replaced as needed.

Reference is now made to FIGS. 3a and 3b, showing front and side views of the handle-like member having a body 110 to be gripped within a user's hand. The body is provided with a slot 120 which is configured for receiving the anchor 230 (see FIGS. 2a and 2b). The anchor is fixatable within the slot 120 such that the worn plectrum arrangement (not show) can be easily replaced as needed.

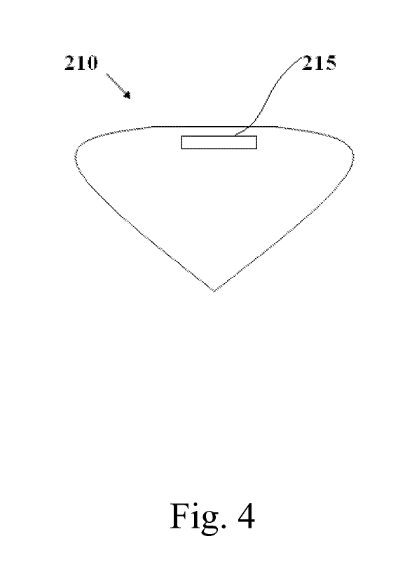

Reference is now made to FIG. 4 showing the plectrum 210, having a slot 215. It should be emphasized that the plectrum 210 configured for hingely connecting to the anchor 230 or to the handle-like member 100 to be gripped by a hand of a user (not shown) is in the scope of the present invention. The aforesaid plectrum is made of a sheet plastic material by means of a punch stamp, which is configured for cutting a plectrum 210. The stamp has an internal puncheon designed for cutting a slot 215 configured for pivotally connecting to a handle-like member 100 to be gripped by a hand of a user or to an anchor 220 releasably connectable to the handle-like member.

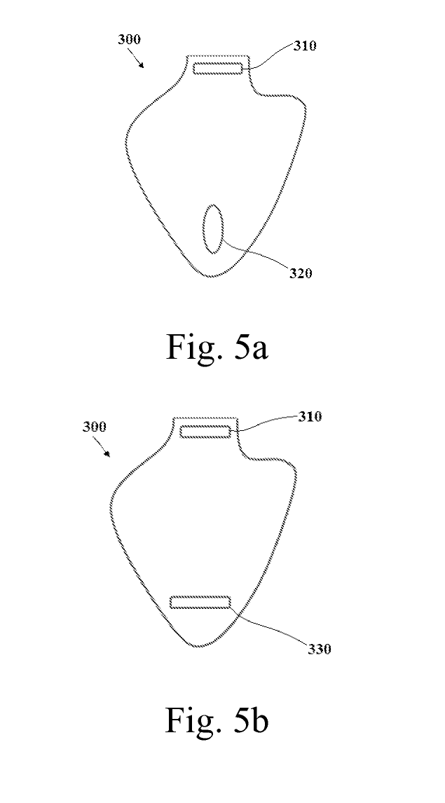

Reference is now made to FIGS. 5a and 5b presenting a plectrum 300 configured to be provided with a heaver (not shown). The heaver can be secured within openings 320 and 330 to provide a more forceful swing and easier string pluck. According to one embodiment of the present invention, a metal heaver is glued within the openings 320 or 330. Any shapes of openings and heavers are in the scope of the present invention.

In accordance with another embodiment of the present invention, the aforesaid plectrum is made by an injection molding process.

In accordance with another embodiment of the present invention, a rotatable portion of the plectrum arrangement can be firmly fixated to the handle-like member, while the plectrum per se is a replaceable portion of the device.

In accordance with a further embodiment of the present invention, a device for playing a string musical instrument is disclosed. The aforesaid device comprises (a) a handle-like member to be gripped by a hand of a user; (b) a plectrum; and (c) a holder of the plectrum mechanically connected to the member; the holder configured for releasably fixating the plectrum therewithin.

It is a core feature of the invention to provide the plectrum holder pivotally connected to the member such that an axis of rotation is in a plane of the plectrum and substantially parallel to instrument strings.

In accordance with a further embodiment of the present invention, the handle-like member is configured into a quadrilateral and substantially flat body with concavely shaped an anterior side, a posterior side and a lower side.

In accordance with a further embodiment of the present invention, the posterior side rests on the fascia over adductor pollicis muscle. The anterior side rests on an index finger. The lower and upper sides are free when said handle-like member is gripped by the user's hand. The plectrum is rotatably movable between a first finger and said index finger.

In accordance with a further embodiment of the present invention, the posterior side rests on the fascia over adductor pollicis muscle. The anterior side rests on a middle finger. The lower and upper sides are free when said handle-like member is gripped by the user's hand. The plectrum is rotatably movable between a first finger and said middle finger.

In accordance with a further embodiment of the present invention, a range of plectrum rotation between the user's fingers is from about 0° to about 120°.

In accordance with a further embodiment of the present invention, the holder is connected to the member by means of a hinge.

In accordance with a further embodiment of the present invention, the holder is integrated with the plectrum.

In accordance with a further embodiment of the present invention, the integrated plectrum is releasably connectable to the member and replaceable as needed.

In accordance with a further embodiment of the present invention, the integrated plectrum is provided with a T-profile member which is insertable into a T-slot within the handle-like member.

In accordance with a further embodiment of the present invention, the device further comprises a wireless unit configured to control a hardware based effects unit connected to said musical instrument and sound effects performable thereby.

In accordance with a further embodiment of the present invention, the device further comprises a wireless unit configured to control a software based effects unit connected to said musical instrument connected to said musical instrument and sound effects performable thereby.

In accordance with a further embodiment of the present invention, the device further comprises a wireless unit configured to control an effects unit that includes both hardware and software based functionality, connected to said musical instrument and sound effects performable thereby.

In accordance with a further embodiment of the present invention, the device further comprises a unit configured for electromagnetic excitation of string oscillation (Ebow). In accordance with a further embodiment of the present invention, the holder comprises a spring-controlled slot configured for receiving and mechanically clamping said plectrum.

In accordance with a further embodiment of the present invention, the holder comprises a member provided with at least one pin to which a conventionally used plectrum being conformably perforated is mechanically clamped.

In accordance with a further embodiment of the present invention, the plectrum is provided with a heaver providing a forceful swing and an easy string pluck.

In accordance with a further embodiment of the present invention, the plectrum is provided with an opening and said heavier is secured in said opening. In accordance with a further embodiment of the present invention, a device for playing a string musical instrument comprises (a) a handle-like member to be gripped by a hand of a user; and (b) a plectrum arrangement comprising an anchor mechanically connectable to the member and a plectrum.

It is another core feature of the invention to provide the plectrum pivotally connected to the anchor such that an axis of rotation is in a plane of the plectrum to be and substantially parallel to instrument strings.

In accordance with a further embodiment of the present invention, a plectrum having an opening configured for pivotally connecting the anchor.

In accordance with a further embodiment of the present invention, a plectrum arrangement releasably fixatable to a handle-like member to be gripped by a hand of a user is disclosed. The aforesaid arrangement comprises an anchor mechanically connectable to the member and a plectrum.

It is a further core feature of the invention to provide the plectrum pivotally connected to the anchor such that an axis of rotation is in a plane of the plectrum to be and substantially parallel to instrument strings.

In accordance with a further embodiment of the present invention, the plectrum has a slot configured for pivotally connecting to a handle-like member to be gripped by a hand of a user.

In accordance with a further embodiment of the present invention, the plectrum is mechanically connected to an anchor releasably connectable to the handle-like member.

In accordance with a further embodiment of the present invention, a punch stamp configured for cutting a plectrum has an internal puncheon designed for cutting an opening configured for configured for pivotally connecting to a handle-like member to be gripped by a hand of a user.

In accordance with a further embodiment of the present invention, a puncheon is designed for cutting a slot configured for an anchor releasably connectable to said handle-like member.

In accordance with a further embodiment of the present invention, a method of playing a musical instrument is disclosed. The aforesaid method comprises the steps of (a) providing a device for playing a string musical instrument; the device comprising (i) a handle-like member to be gripped by a hand of a user; (ii) a plectrum; and (iii) a holder of the plectrum mechanically connected to the member; the holder configured for releasably fixating the plectrum therewithin; the plectrum holder is pivotally connected to the member such that an axis of rotation is in a plane of the plectrum and substantially parallel to instrument strings; (b) gripping the device by the user's hand; (c) picking the strings by means of the plectrum.

It is a further core feature of the invention to step of plucking strings which comprises rotating the plectrum around an axis which is in a plane of the plectrum and substantially parallel to instrument strings.

1-60. (canceled)

61. A device for playing a stringed musical instrument; said device comprising
a. a handle-like member to be gripped by a hand of a user;
b. a plectrum; and
c. a holder of said plectrum mechanically connected to said member; said holder configured for releasably fixating said plectrum therewithin;
wherein said plectrum holder is pivotally connected to said member such that said holder is freely rotatable around an axis of rotation is in a plane of said plectrum and parallel to instrument strings.

62. The device according claim 61, wherein said handle-like member is configured into a quadrilateral and flat body with concavely shaped anterior side, posterior side and lower side.

63. The device according claim 62, said posterior side configured to rest on the fascia over adductor pollicis muscle; said anterior side configured to rest on an index finger, said lower and upper sides are free when said handle-like member is gripped by the user's hand; said plectrum is rotatably movable between a first finger and said index finger.

64. The device according claim 62, said posterior side rests on the fascia over adductor pollicis muscle; said anterior side rests on a middle finger, said and upper sides are free when said handle-like member is gripped by the user's hand; said plectrum is rotatably movable between a first finger and said middle finger.

65. The device according claim 61, wherein at least one of the following is true:
a. a range of plectrum rotation between the user's fingers is from about 0 to about 120°;
b. said holder is connected to said member by means of a hinge.
c. holder is integrated with said plectrum;
d. said the plectrum made by an injection molding process;
e. said holder comprises a spring-controlled slot configured for receiving and mechanically clamping said plectrum;
f. said holder comprises a member provided with at least one pin to which a conventionally used plectrum being conformably perforated is mechanically clamped;
g. said device comprises a unit configured for electromagnetic excitation of string oscillation (ebow).
h. said device comprises a wireless unit configured to control a hardware connected to said musical instrument and sound effects performable thereby;
i. said device comprises a wireless unit configured to control a software based effects unit connected to said musical instrument connected to said musical instrument and sound effects performable thereby; and
j. said plectrum is provided with a heaver providing a forceful swing and an easy string pluck.

66. The device according claim 65, wherein at least one of the following is true:
a. aid integrated plectrum is releasably connectable to said member and replaceable as needed;
b. said integrated plectrum is provided with a T-profile member which is insertable into a T-slot within said handle-like member.

67. The device according claim 65, wherein said plectrum is provided with an opening and said heavier is secured in said opening.

68. A device for playing a stringed musical instrument; said device comprising:
a. a handle-like member to be gripped by a hand of a user;
b. a plectrum arrangement comprising an anchor mechanically connectable to said member and a plectrum;
wherein said plectrum holder is pivotally connected to said member such that said holder is freely rotatable around an axis of rotation is in a plane of said plectrum and parallel to instrument strings.

69. The device according claim 68, wherein said handle-like member is configured into a quadrilateral and flat body with concavely shaped anterior side, posterior side and lower side.

70. The device according claim 69, said posterior side configured to rest on the fascia over adductor pollicis muscle; said anterior side configured to rest on an index finger, said lower and upper sides are free when said handle-like member is gripped by the user's hand; said plectrum is rotatably movable between a first finger and said index finger.

71. The device according claim 69, said posterior side rests on the fascia over adductor pollicis muscle; said anterior side rests on a middle finger, said lower and upper sides are free when said handle-like member is gripped by the user's hand; said plectrum is rotatably movable between a first finger and said middle finger.

72. The device according claim 68, wherein at least one of the following is true:
a. a range of plectrum rotation between the user's fingers is from about 0 to about 120°;
b. said anchor and said plectrum are interconnected by means of a hinge;
c. said holder comprises a spring-controlled slot configured for receiving and mechanically clamping said plectrum;
d. said holder comprises a member provided with at least one pin to which a conventionally used plectrum being conformably perforated is mechanically clamped;
e. said plectrum is provided with a heaver providing a forceful swing and an easy string pluck;
f. said device comprises a wireless unit configured to control a hardware based effects unit connected to said musical instrument and sound effects performable thereby;
g. said device comprises a wireless unit configured to control a software based effects unit connected to said musical instrument connected to said musical instrument and sound effects performable thereby;
h. said device comprises a unit configured for electromagnetic excitation of string oscillation (ebow)

73. The device according claim 72, wherein one of the following is true:
a. said plectrum arrangement is releasably connectable to said member and replaceable as needed;
b. said anchor is provided a T-profile member which is insertable into a T-slot within said handle-like member.

74. The device according claim 72, wherein said plectrum is provided with an opening and said heavier is secured in said opening.

75. A plectrum arrangement releasably fixatable to a handle-like member to be gripped by a hand of a user; said arrangement comprising
a. an anchor mechanically connectable to said member and
b. a plectrum;
wherein said plectrum holder is pivotally connected to said member such that said holder is freely rotatable around an axis of rotation is in a plane of said plectrum and parallel to instrument strings.
